(19) United States
(12) Patent Application Publication
(10) Pub. No.: US 2025/0137228 A1
(43) Pub. Date: May 1, 2025

(54) PIN RETAINER

(71) Applicant: CNC INDUSTRIES LTD., Nisku (CA)

(72) Inventors: Muhammad SHEHARYAR, Edmonton (CA); Michael Parker, Edmonton (CA); Kristofer HENKE, Edmonton (CA); Paramdeep GILL, Spruce Grove (CA)

(21) Appl. No.: 18/933,699

(22) Filed: Oct. 31, 2024

(30) Foreign Application Priority Data
Oct. 31, 2023 (CA) 3,218,154

(51) Int. Cl. E02F 9/00

(52) U.S. Cl. CPC E02F 9/006

(57) ABSTRACT

A retainer for a padlock pin. The padlock pin is adapted to connect a padlock to a lug of a bucket of a rope shovel. The retainer comprises a pin attachment portion rotationally fixed to the padlock pin, and an arm, the arm comprising a bucket-facing surface. The bucket-facing surface sized to prevent rotation of the padlock pin.

### CROSS-REFERENCE TO RELATED APPLICATION

This non-provisional application claims priority under 35 U.S.C. § 119(a) on Canadian Patent Application No. 3,218,154 filed on Oct. 31, 2023, the entire contents of which are hereby incorporated by reference.

### TECHNICAL FIELD

Hinge elements, particularly for rope shovels for mining.

### BACKGROUND

In rope shovels, a bucket is hingedly connected to a bucket handle and separately hingedly connected to a receiver for a hoist rope. These connections cooperate to move and support the bucket. The hinged connection between the bucket and the receiver for the hoist rope conventionally comprises a lug attached to the bucket, and an element referred to herein as a padlock which connects to the receiver for the hoist rope, the padlock having two lugs, one on each side of the lug of the bucket. A pin, referred to herein as a padlock pin, is inserted through the lugs to form a hinge. The pin may also be referred to as a bail pin or an equalizer pin, and for the purposes of this document, these terms should be considered interchangeable, and the use of a particular term should not be limiting. This hinge is exposed to a great deal of force during normal use of the rope shovel. Conventionally, to provide bearing surfaces for the pin, bushings are provided within the lugs. In the conventional design, the pin can rotate with respect to the bucket and the associated bushing (main lug bushing), causing wear due to the rotational friction of the pin with the bushing.

### SUMMARY

In an embodiment there is a retainer for a padlock pin. The padlock pin may be adapted to connect a padlock to a lug of a bucket of a rope shovel. The retainer may comprise: a pin attachment portion rotationally fixed to the padlock pin, the pin attachment portion comprising an aperture for receiving the padlock pin, and an arm, the arm comprising a bucket-facing surface, wherein the bucket-facing surface has a length along a plane that is perpendicular to a center-axis of the padlock pin, and wherein the length is larger than a maximum distance across the aperture.

In an embodiment, there is a retainer for a padlock pin. The padlock pin may be adapted to connect a padlock to a lug of a bucket of a rope shovel. The retainer may comprise: a pin attachment portion adapted to be rotationally fixed to the padlock pin, and an arm, the arm comprising a bucket-facing surface, wherein the bucket-facing surface has a length along a plane that is perpendicular to a center-axis of the padlock pin, and wherein the length is at least 50% of a minimum distance from the bucket-facing surface to the center-axis of the padlock pin.

In various embodiments, there may be included one or more of the following features: the length is at least 90% of the minimum distance from the bucket-facing surface to the center-axis of the padlock pin.

In an embodiment, there is a retainer for a padlock pin. The padlock pin may be adapted to connect a padlock to a lug of a bucket of a rope shovel. The retainer may comprise: a pin attachment portion adapted to be rotationally fixed to the padlock pin, and an arm, the arm having a length and a second length along a plane that is perpendicular to a center-axis of the padlock pin, and wherein the length is larger than the second length.

In various embodiments, there may be included one or more of the following features: the length is larger than the second length by at least 25%; the length is larger than the second length by at least 50%; a transition between the length and the second length forms a wedge shape; the length is 15 inches to 21 inches; the length is 17 inches to 19 inches.

In an embodiment, there is a retainer for a padlock pin. The padlock pin may be adapted to connect a padlock to a lug of a bucket of a rope shovel. The retainer may comprise: a pin attachment portion adapted to be rotationally fixed to the padlock pin, and an arm, the arm comprising a bucket-facing surface, wherein the bucket-facing surface has an area sized to prevent yielding of 30%-100% of the area when the padlock pin is subject to a rotational load.

In various embodiments, there may be included one or more of the following features: the area is sized to prevent yielding of 60%-100% of the area when the padlock pin is subject to the rotational load; the bucket-facing surface comprises a steel with a yield point of 32,000 psi-40,000 psi; the bucket-facing surface comprises a steel with a yield point of 21,000 psi-31,999 psi; the bucket-facing surface comprises a steel with a yield point of 79,000 psi-110,000 psi; the pin attachment portion is attached to an end of the padlock pin; the bucket-facing surface is adapted to contact a portion of the bucket of the rope shovel.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective drawing of a padlock with a retainer according to an embodiment of the present invention shown in the context of a bucket of a rope shovel;

FIG. 2 is a side view of the padlock of FIG. 1;

FIG. 3 is a front view of the padlock of FIG. 1, where front is the direction shown to the right in FIG. 2 and lower right in FIG. 1, shown in context of a portion of the bucket;

FIG. 3A is a section view showing the section indicated by line A-A in FIG. 3, showing interior details of the padlock;

FIG. 3B is a close up of the section of the padlock, showing the area indicated by circle B in FIG. 3A;

FIG. 4 is a front view of an embodiment of a retainer.

FIG. 5 is a side view of the embodiment of the retainer shown in FIG. 4.

FIG. 6 is a perspective view of the embodiment of the retainer shown in FIG. 4.

FIG. 7 is a perspective view of an embodiment of a bucket and a plurality of retainers.

### DETAILED DESCRIPTION

Embodiments are shown in the context of the bucket 10 of a Bucyrus™ 495 rope shovel, but the invention is not limited to any particular variety of rope shovel and could also be applied to hinges in contexts other than rope shovels. For example, the embodiment may be used for a CAT™ 7495/BI495 electric rope shovel or a P & H™ 4100 electric rope shovel. Further, in various embodiments, a bail or equalizer may be used in place of the padlock 16.

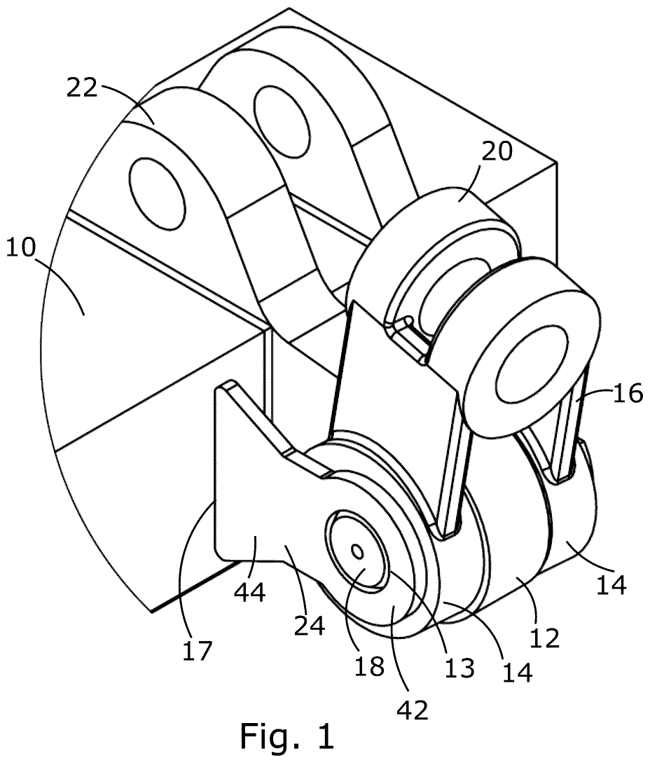

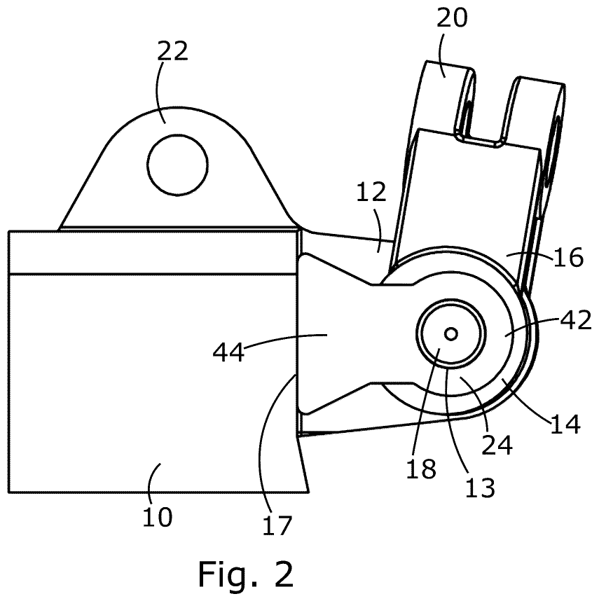

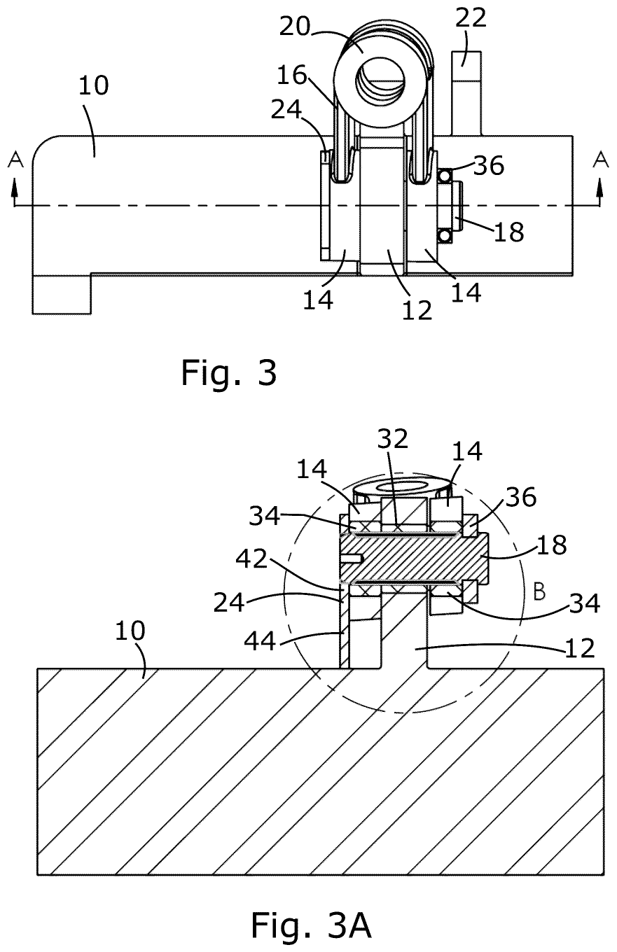

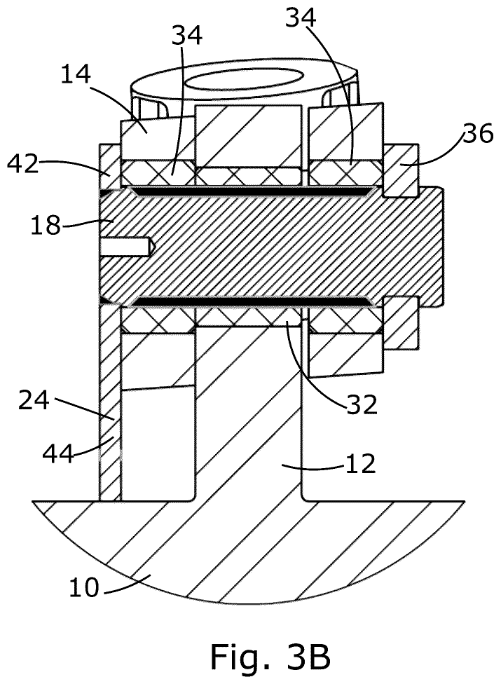

FIG. 1 is a perspective drawing of a padlock 16 with a retainer 24 according to an embodiment of the present invention shown in the context of a bucket 10 of a rope shovel, and FIG. 2 is a side view of the padlock 16 of FIG. 1. FIG. 3 is a front view of the embodiment.

As shown in FIG. 1, FIG. 2 and FIG. 3, the padlock pin 18 is adapted to connect a padlock 16 to a lug 12 of a bucket 10 of a rope shovel. A bucket 10 of a rope shovel has a bucket lug 12 for forming a hinged connection to lugs 14 of padlock 16. Padlock pin 18 is inserted through bucket lug 12 and padlock lugs 14 to form the hinged connection. The padlock 16 has lugs 20 to form a hinged connection with a receiver for a hoist rope (not shown). Bucket 10 also has lugs 22 to form a hinged connection with a bucket handle (not shown).

There is disclosed an embodiment of a retainer 24 for a padlock pin 18. The retainer 24 comprises a pin attachment portion 42 rotationally fixed to the padlock pin 18. The pin attachment portion 42 may include an aperture 13 for receiving the padlock pin 18. The pin attachment portion 42 may be attached to the padlock pin 18 by any other means that rotationally fixes the components. For example, the connection may be a press fit, keyed shaft, or set screw type connection. The connection may also be made by welding. The connection may also be made by a groove in the padlock pin 18 that receives the retainer 24. The connection may be rigidly connected in rotation but moveable axially. The connection may be rigidly connected in rotation and rigidly connected axially.

The retainer 24 further comprises an arm 44. The arm 44 comprises a bucket-facing surface 17. The bucket-facing surface 17 is adapted to contact a portion of the bucket 10 of the rope shovel. The contact surface of the bucket 10 and the bucket-facing surface 17 may be flat or any other shape that prevents rotation of the retainer 24 and padlock pin 18 with respect to the bucket 10. The bucket-facing surface 17 may be configured to match any complex bucket shape. When the bucket 10 rotates, the padlock lugs 14 apply a rotational load to the padlock pin 18 as a result of friction forces. The rotational load on the padlock pin 18 is transferred to the retainer 24. The retainer 24 prevents the rotation of the padlock pin 18 by contact between the bucket-facing surface 17 and the bucket 10.

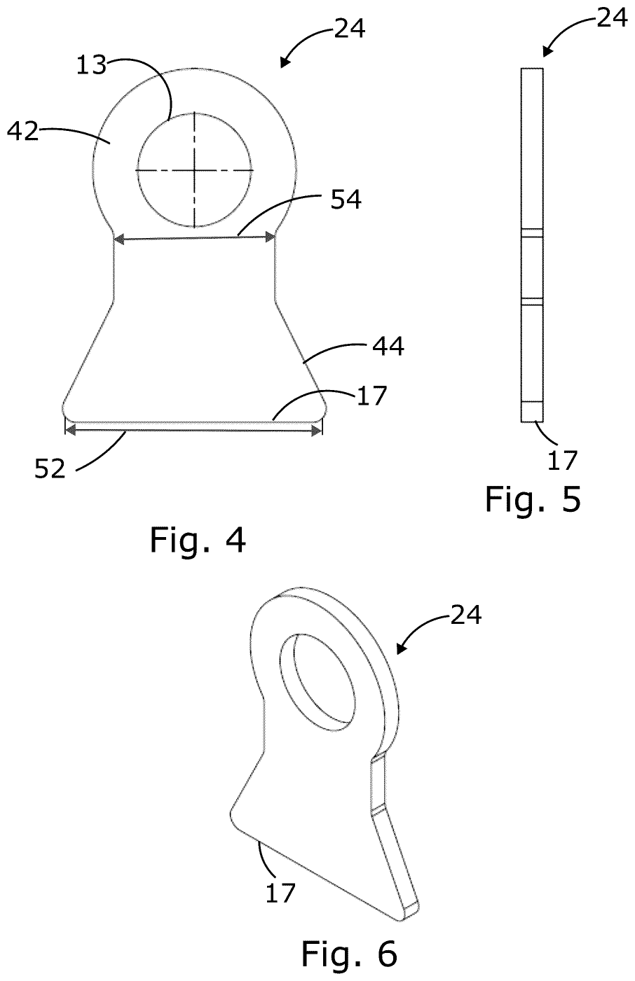

The bucket-facing surface 17 comprises a surface that faces the bucket 10 and has a length 52 (shown in FIG. 4). The length 52 may be along a plane that is perpendicular to a center-axis of the padlock pin 18. The length 52 is sized to restrain rotation of the padlock pin 18. By way of example, the following embodiments comprise a length 52 that restrains rotation of the padlock pin 18: the bucket-facing surface 17 may have a length 52 that is larger than a maximum distance across the aperture 13; the bucket-facing surface 17 may have a length 52 that is at least 50% of a minimum distance from the bucket-facing surface 17 to a center point of the aperture 13; the bucket-facing surface 17 may have a length 52 that is at least 90% of the minimum distance from the bucket-facing surface 17 to the center point of the aperture 13; the bucket-facing surface 17 may have a length 52 that is at least 50% of a minimum distance from the bucket-facing surface 17 to a center-axis of the padlock pin 18; the bucket-facing surface 17 may have a length 52 that is at least 90% of the minimum distance from the bucket-facing surface 17 to the center-axis of the padlock pin 18; the length 52 of the bucket-facing surface 17 may be 15 inches to 21 inches; and the length 52 of the bucket-facing surface 17 may be 17 inches to 19 inches. In one embodiment, the bucket-facing surface 17 may be 18 inches in length.

The bucket-facing surface 17 may yield because of the contact between the bucket-facing surface 17 and the bucket 10. The yielding may be in the form of compression on the surface of the bucket-facing surface 17. The area of the bucket-facing surface 17 may be sized to prevent the yielding and thereby prevent rotation of the padlock pin 18. The bucket-facing surface 17 may have an area sized to prevent yielding of 30%-100% of the area when the padlock pin 18 is subject to a rotational load. The area may be sized to prevent yielding of 60%-100% of the area when the padlock pin 18 is subject to the rotational load. These areas allow for some compression of the bucket-facing surface 17 while preventing the padlock pin 18 from rotating.

The material of the bucket-facing surface 17 may be selected to prevent yielding. The bucket-facing surface 17 may comprise a steel with a yield point of 32,000 psi-40,000 psi. The bucket-facing surface 17 may comprise a steel with a yield point of 21,000 psi-31,999 psi. The bucket-facing surface 17 may comprise a steel with a yield point of 79,000 psi-110,000 psi. Any steel or other material that prevents yielding of the appropriate amount of area may be used.

As may be seen in FIG. 4-6, the arm 44 may have a second length 54. The second length 54 is along a plane that is perpendicular to the center-axis of the padlock pin 18. The length 52 is larger than the second length 54 by an amount that restrains rotation of the padlock pin 18 and, simultaneously, prevents bending of the arm 44. For example, this feature is provided where the length 52 is larger than the second length 54 by at least 25%. Further, this feature is provided where the length 52 is larger than the second length 54 by at least 50%. There may be a transition between the length 52 and the second length 54 that forms a wedge shape. For example, the bucket-facing surface 17 may have a length 52 that is larger than any other length of the retainer 24 that is parallel to the length 52. The length of the retainer 24 may increase as it approaches the bucket-facing surface, for example, by having the wedge shape shown in FIGS. 4 and 6.

The pin attachment portion 42 and arm 44 may be made of a single unitary piece of material or of two components rigidly connected. The components could be made of additional portions as long as they are sufficiently rigidly connected to one another. If the padlock pin 18 extends some distance beyond the lugs 14, then any position on the pin beyond the lugs 14 is considered to be the “end” of the padlock pin 18. The pin attachment portion 42 may be attached to an end of the padlock pin 18. It is possible that a padlock 16 may be configured to have a space between a padlock lug 14 and a bucket lug 12 to receive a retainer 24 of the padlock pin 18. In that case, the retainer 24 could extend between any of the lugs 12, 14 that receive the padlock pin 18 and would, in this case, not be at the end of the padlock pin 18. The retainer 24 may be removably attached in that case to enable the pin to be removed.

The retainer 24 may extend perpendicularly to the axis of the padlock pin 18, so that the retainer 24 is subject to only bending and not twisting forces and does not apply forces to the padlock pin 18 that are outside the plane perpendicular to the axis of the padlock pin 18. Additionally, a retainer 24 that may be bent away from a direction perpendicular to the axis of the padlock pin 18 could be used.

As is shown in FIGS. 3, 3A and 3B, a collar assembly 36 may secure an end of the padlock pin 18, opposite to the retainer 24, to prevent the padlock pin 18 from sliding through the lugs 14. Section line A-A indicates the section shown by FIG. 3A. Circle B in FIG. 3A indicates the area shown close up in FIG. 3B. As shown in FIG. 3A and FIG. 3B, bucket lug 12 and padlock lugs 14, respectively may contain bushings 32 and 34. The bushings 32, 34 may provide bearing surfaces for the padlock pin 18. The retainer 24 for the padlock pin 18, by restraining rotation of the padlock pin 18 relative to the bucket 10, prevents the padlock pin 18 from spinning on bushing 32, forcing the bushings 34 to deal with rotational friction relative to the padlock pin 18 instead of bushing 32. This also reduces wear on the bucket lug 12 which is not as readily replaced or repaired as the padlock 16.

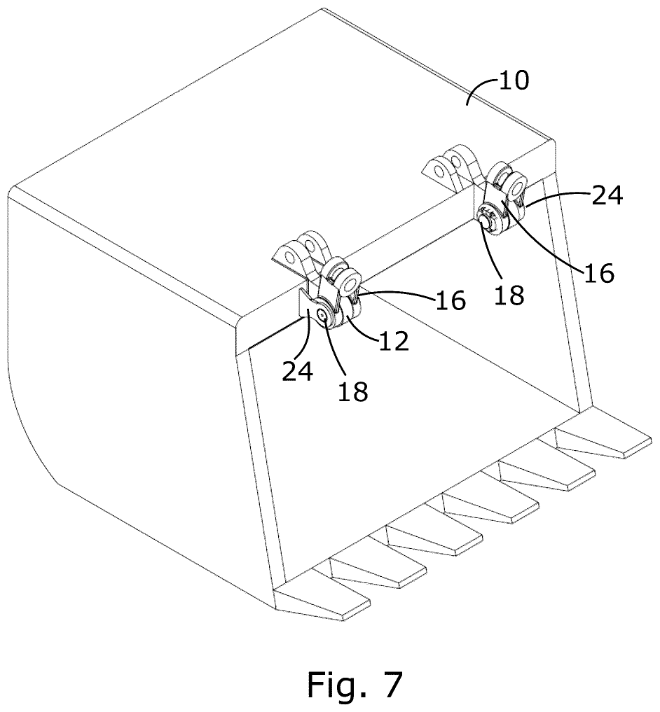

FIG. 7 shows an embodiment of a bucket 10 wherein two padlocks 16 are connected to the bucket 10. Each padlock 16 is connected to the bucket 10 by a padlock pin 18. A retainer 24 is fixed rotationally to each padlock pin 18. There may be more than one retainer 24 on each padlock pin 18 or a single retainer 24 on each padlock pin 18.

In one or more embodiments there may be the following advantages. Additional components do not need to be welded on the bucket to prevent rotation of the padlock pin 18. As a result, there are no heat affected zones and potential stress concentrations that are normally caused by the welding. Additionally, the retainer 24 is easily installed on the bucket 10. Modifications of the bucket 10 are not required, namely, welding or drilling. Further, there are no additional holes required in the bucket 10. The addition of holes would normally decrease the strength of the bucket 10 side wall and increase the stress-multiple around the hole. This generally reduces the load bearing capacity and life of the bucket 10. A further advantage is that the bucket-facing surface 17 may be adapted to match any bucket 10 shape from various manufacturers.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

What is claimed is:

1. A retainer for a padlock pin, the padlock pin being adapted to connect a padlock to a lug of a bucket of a rope shovel, the retainer comprising:
a pin attachment portion fixed rotationally to the padlock pin, the pin attachment portion comprising an aperture for receiving the padlock pin; and
an arm, the arm comprising a bucket-facing surface, wherein the bucket-facing surface has a length along a plane that is perpendicular to a center-axis of the padlock pin, and wherein the length is larger than a maximum distance across the aperture.

2. A retainer for a padlock pin, the padlock pin being adapted to connect a padlock to a lug of a bucket of a rope shovel, the retainer comprising:
a pin attachment portion adapted to be rotationally fixed to the padlock pin; and
an arm, the arm comprising a bucket-facing surface, wherein the bucket-facing surface has a length along a plane that is perpendicular to a center-axis of the padlock pin, and wherein the length is at least 50% of a minimum distance from the bucket-facing surface to the center-axis of the padlock pin.

3. The retainer of claim 2, wherein the length is at least 90% of the minimum distance from the bucket-facing surface to the center-axis of the padlock pin.

4. A retainer for a padlock pin, the padlock pin being adapted to connect a padlock to a lug of a bucket of a rope shovel, the retainer comprising:
a pin attachment portion adapted to be rotationally fixed to the padlock pin; and
an arm, the arm having a length and a second length along a plane that is perpendicular to a center-axis of the padlock pin, and wherein the length is larger than the second length.

5. The retainer of claim 4, wherein the length is larger than the second length by at least 25%.

6. The retainer of claim 4, wherein the length is larger than the second length by at least 50%.

7. The retainer of claim 4, wherein a transition between the length and the second length forms a wedge shape.

8. The retainer of claim 1, wherein the length is 15 inches to 21 inches.

9. The retainer of claim 8, wherein the length is 17 inches to 19 inches.

10. A retainer for a padlock pin, the padlock pin being adapted to connect a padlock to a lug of a bucket of a rope shovel, the retainer comprising:
a pin attachment portion adapted to be rotationally fixed to the padlock pin; and
an arm, the arm comprising a bucket-facing surface, wherein the bucket-facing surface has an area sized to prevent yielding of 30%-100% of the area when the padlock pin is subject to a rotational load.

11. The retainer of claim 10, wherein the area is sized to prevent yielding of 60%-100% of the area when the padlock pin is subject to the rotational load.

12. The retainer of claim 10, wherein the bucket-facing surface comprises a steel with a yield point of 32,000 psi-40,000 psi.

13. The retainer of claim 10, wherein the bucket-facing surface comprises a steel with a yield point of 21,000 psi-31,999 psi.

14. The retainer of claim 10, wherein the bucket-facing surface comprises a steel with a yield point of 79,000 psi-110,000 psi.

15. The retainer of claim 1, wherein the pin attachment portion is attached to an end of the padlock pin.

16. The retainer of claim 1, wherein the bucket-facing surface is adapted to contact a portion of the bucket of the rope shovel.
